(19) United States
(12) Patent Application Publication
(10) Pub. No.: US 2016/0230739 A1
(43) Pub. Date: Aug. 11, 2016

(54) SEMISUBMERSIBLE PLATFORM EQUIPPED WITH AN ANGULAR AMPLIFICATION SYSTEM

(71) Applicant: WAVES RUIZ, Octeville Sur Mer (FR)

(72) Inventor: Jose Antonio RUIZ DIEZ, Octeville Sur Mer (FR)

(73) Assignee: WAVES RUIZ, Octeville Sur Mer (FR)

(21) Appl. No.: 15/022,971

(22) PCT Filed: Sep. 16, 2014
(86) PCT No.: PCT/FR2014/052300

§ 371 Date: Mar. 18, 2016

(30) Foreign Application Priority Data
Sep. 20, 2013 (FR) 13 59085

(51) Int. Cl. F03B 13/20

(52) U.S. Cl. CPC F03B 13/20

(57) ABSTRACT

Wave power generator (1), which has a semi-submersible platform (2) with at least one longitudinal box (4) that extends from a bow (7) to a stern (8) of the platform (2). The platform (2) has at its bow (7) a stabilizing aileron (12) that extends transversely below a lower edge (9) of the box (4), and at its stern (8) a flotation beam (11) integral with the box (4). A wave energy converter machine (3) is mounted on the platform (2), which includes a gantry (17) mounted transversely on the box (4) at the bow of the platform (2), at least one float (18) that allows the transformation of the wave energy into mechanical energy, the float (18) mounted on an arm (20) mounted in rotation on a shaft (21) integral with the gantry (17), and a converter (23) of mechanical energy from the float (18) into hydraulic energy.

The invention relates to the domain of energy production, and more specifically to the domain of electrical energy production from wave energy.

The invention concerns a wave power generator equipped with a platform and a wave energy converter machine mounted on said platform and equipped with floats, the ascending and descending movement of which, following the wave (which also exerts a horizontal thrust on the floats), is converted into hydraulic energy, said hydraulic energy in turn being converted into electrical energy by means of a hydraulic motor associated with a generator, or a hydroelectric turbine.

A wave power generator of this type is known in particular from document US 2013/067903 (Sea Power Ltd.). Said power generator comprises two floats (called pontoons in the document) that are mutually articulated by arms. Said floats are designed to follow the vertical movements of the wave and produce mechanical energy by mutual rotation.

Such architecture is not without its disadvantages. In particular, the power generator is sensitive to listing, caused by the lateral pressure exerted by the water on the front of the floats. Said pressure is not constant over the whole length of the power generator. Also, the listing generates torsion stresses in the articulation arms that can accelerate the aging of the structure by mechanical fatigue. In rough seas, there is no small risk of breakage. One solution would be to re-dimension the arms to increase their rigidity, but this would result in increasing their inertia, to the detriment of the energy production of the power generator.

A first objective is to propose a wave power generator having increased energy output.

A second objective is to propose a wave power generator having increased stability, in particular with respect to listing.

A third objective is to propose a wave power generator having increased compactness, particularly to the benefit of the rigidity and manufacturing costs.

A fourth objective is to propose a wave power generator having good reliability, so as to minimize maintenance operations.

To that end, a wave power generator is proposed, which comprises:
a semi-submersible platform provided with at least one longitudinal box that extends from a bow to a stern of the platform, said platform having at its bow a stabilizing aileron that extends transversely below a lower edge of the box, and at its stern a transverse flotation beam integral with the box;
a wave energy converter machine mounted on the platform, said machine comprising:
   a gantry mounted transversely on the box at the bow of the platform,
   at least one float arranged to allow the transformation of the wave energy into mechanical energy, the float being mounted on an arm mounted in rotation on a shaft integral with the gantry,
   a converter of mechanical energy from the float into hydraulic energy.

As a result of this architecture, the float and the floatation beam can be propelled in oscillating movements in reverse direction, maximizing the angular travel of the arm (and thus the production of the power generator).

Various characteristics can be provided, alone or in combination:
the beam has a circular contour in longitudinal cross-section;
the beam extends to about halfway up the box;
the box or each box has, at the stern, a widened and/or raised end;
the gantry extends directly above the aileron;
each converter comprises a pair of hydraulic cylinders functioning preferably by tension, for example in opposition, the pistons of which are coupled to the arm;
each arm is rigid;
each arm is rigidly integral with the float;
each float comprises a hydrodynamic appendage in the form of a trough attached beneath a hull of the float;
the wave power generator comprises at least two longitudinal boxes defining a central channel in which the float is disposed, wherein the gantry is mounted transversely between the boxes, and wherein the flotation beam transversely connects the boxes.

Other objects and advantages of the invention will be seen from the description of one embodiment, provided below with reference to the appended drawings in which:

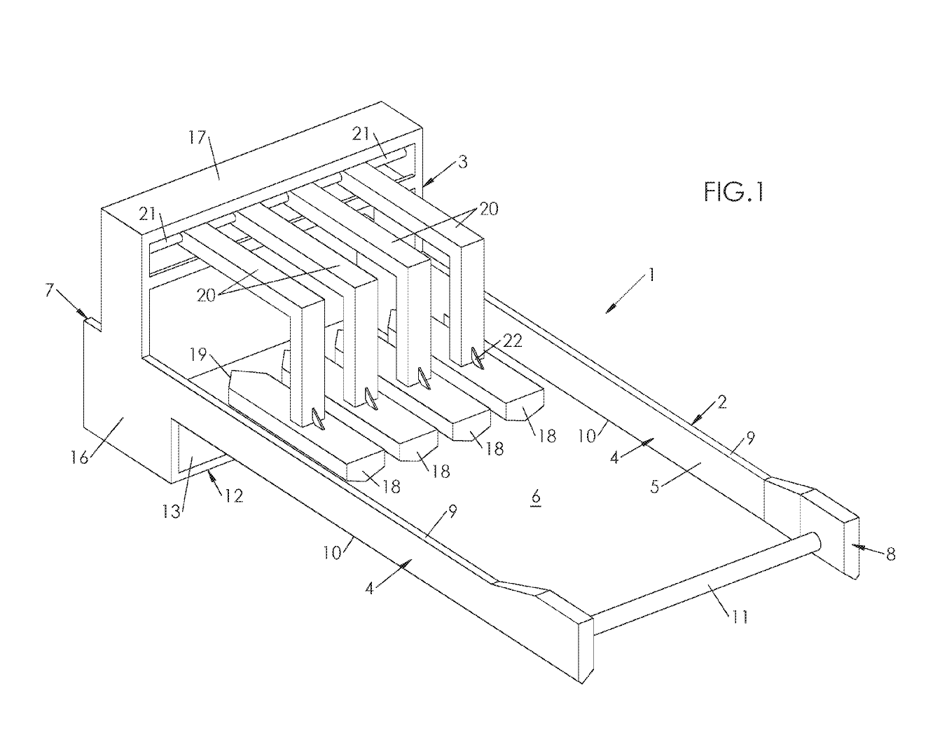

FIG. 1 is a view in perspective of a wave power generator;

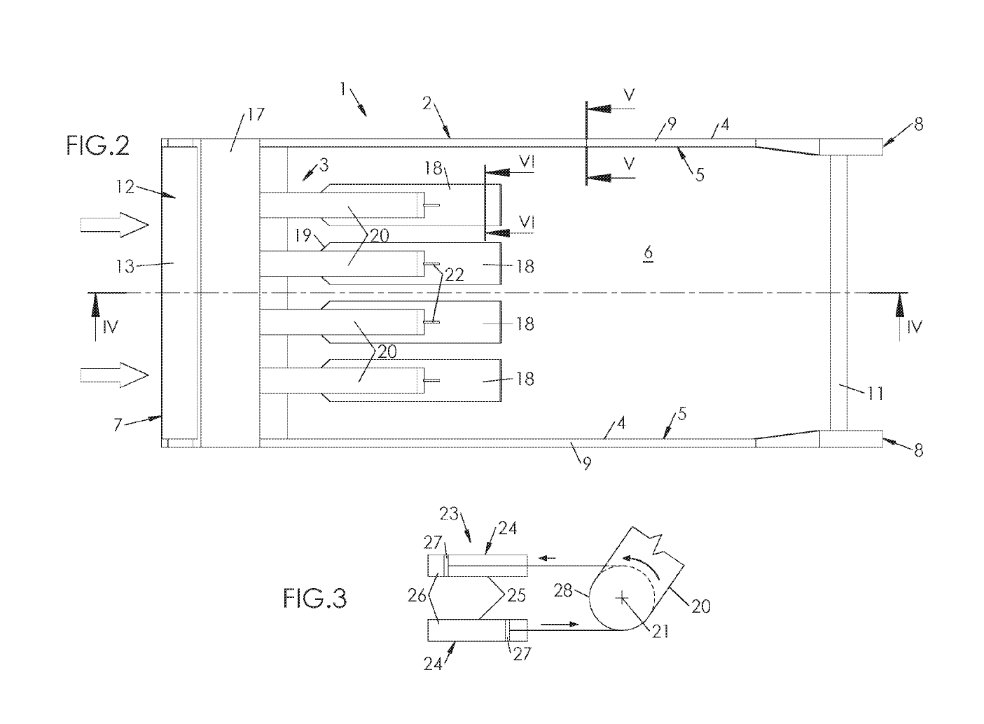

FIG. 2 is a top view of the wave power generator of FIG. 1;

FIG. 3 is a diagrammatic view showing an energy converter with which the power generator is equipped;

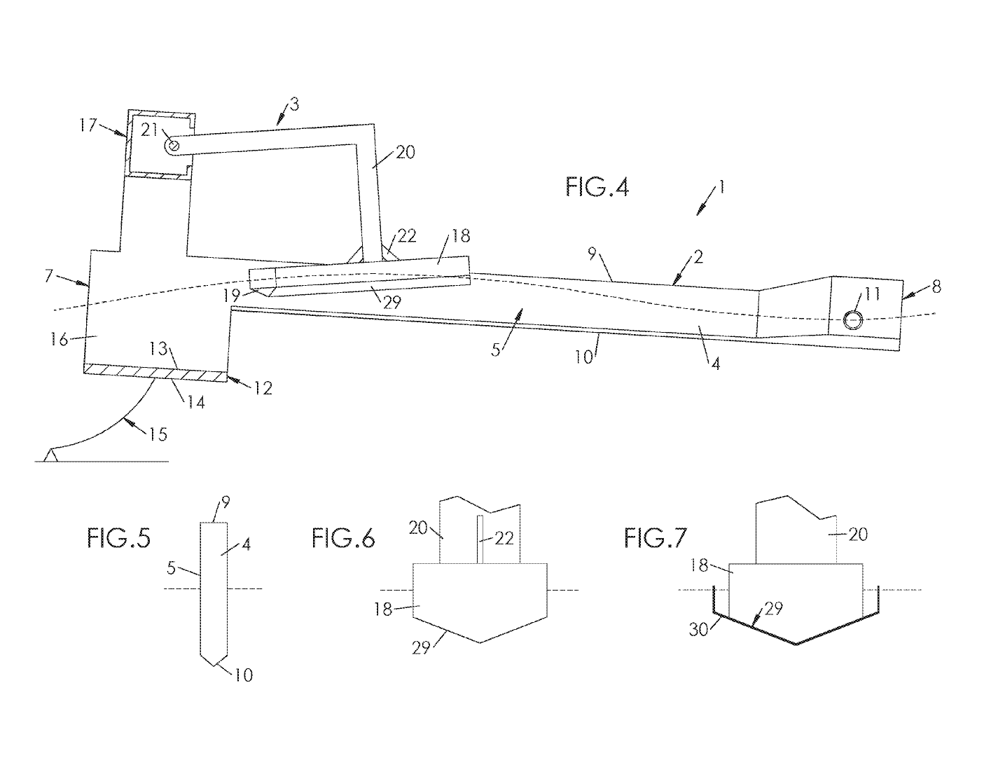

FIG. 4 is a view in cross-section of the power generator of FIG. 2, along the cutting plane IV-IV;

FIG. 5 is a detail [view] in cross-section showing a box of the power generator of FIG. 2, along the cutting plane V-V;

FIG. 6 is a detail view in cross-section showing a float of the power generator of FIG. 2, along the cutting plane VI-VI;

FIG. 7 is a view similar to FIG. 6, showing a float according to a variant of embodiment in which the float is equipped with a hydrodynamic appendage;

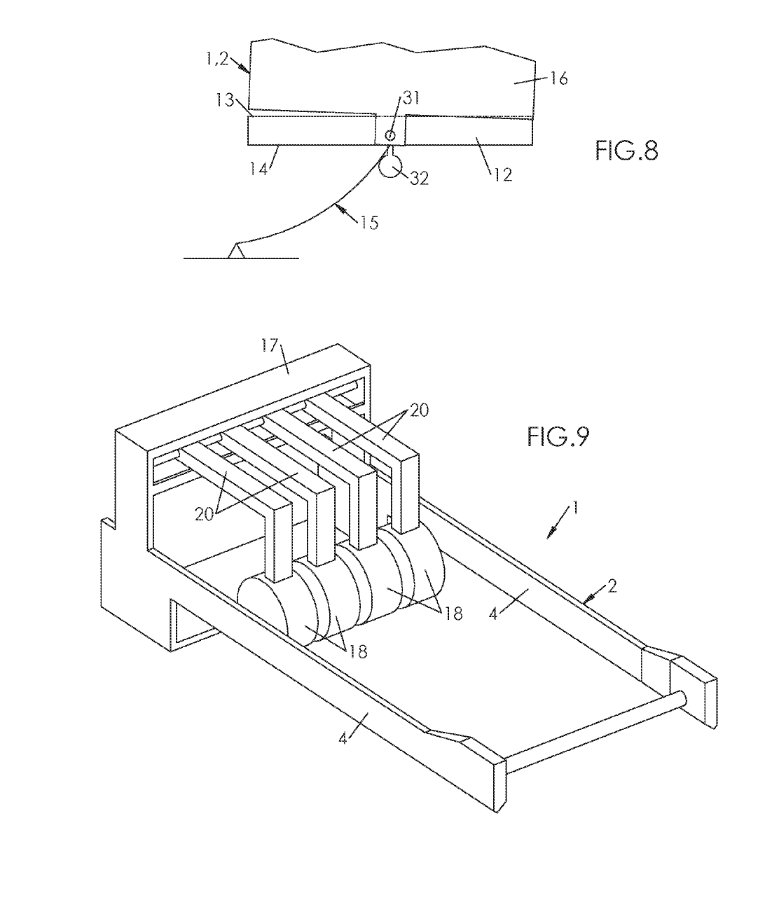

FIG. 8 is a detail side view showing the power generator according to a variant of embodiment;

FIG. 9 is a view similar to FIG. 8, showing the power generator according to another variant of embodiment;

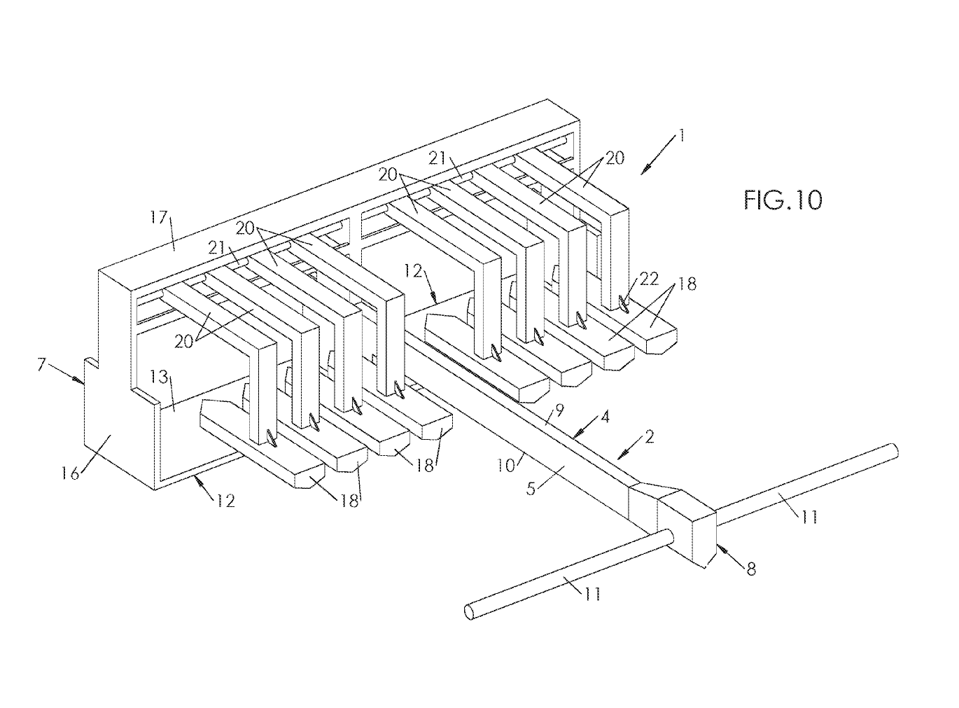

FIG. 10 is a view similar to FIG. 1, showing the power generator according to still another variant of embodiment.

Represented in FIG. 1 is a wave power generator 1. Said power generator 1, intended to be installed offshore, comprises a semi-submersible platform 2 and a wave energy converter machine 3 mounted on the platform 2.

The semi-submersible platform 2 is equipped with a plurality of elongated floating boxes 4, disposed substantially parallel along a longitudinal direction that, when the power generator 1 is at sea, corresponds to the principal direction of wave propagation (represented by the arrows at left in FIG. 2).

In the illustrated example, the boxes 4 are two in number, are parallelepiped in shape, of square or rectangular (as illustrated) cross-section, and have a height that is preferably greater than their thickness. The boxes 4 have side walls 5 that are solid or openwork, which together define a central channel 6 that extends from a bow 7 (at left in FIGS. 1, 2 and 4) to a stern 8 (at right in FIGS. 1, 2 and 4) of the platform 2.

Thanks to the side walls 5 of the boxes 4, the seawater is channeled into the channel 6 along the principal direction of wave propagation, which limits the rolling movements (or listing) of the platform 2.

Each box 4 has an upper longitudinal edge 9 and an opposite lower longitudinal edge 10, which, in calm (albeit with groundswell) to moderately rough seas, can be respectively emerged and immersed.

Each box 4 is preferably hollow, and is produced by an assembly of metal plates (for example steel treated for anticorrosion), composite material or any other material that is sufficiently rigid and resistant to bending forces as well as to corrosion. Each box 4 can be stiffened by means of internal ribs, in order to better resist bending stresses both in the longitudinal plane (particularly when the box extends to overhang the crest of a wave, or when it is carried at both ends by two successive crests) as well as in the transverse plane (particularly in the event of local vortex).

Furthermore, each box 4 can be compartmentalized to form ballasts that can be at least partially filled with seawater or emptied in order to adjust the waterline. The filling and emptying of the ballasts can be achieved by means of pumps, preferably actuated automatically. Such adjustment is preferably made in such a way that the waterline is substantially midway on the boxes 4—in other words, so that the draft and the freeboard of the boxes 4 are substantially identical.

According to one embodiment illustrated in FIGS. 1, 2 and 4, each box 4 has, at the stern 8, an end that is widened (as can be seen more particularly in FIG. 2) and/or raised (as can be seen more particularly in FIG. 4). Thus, the volume of air trapped in the boxes 4 is greater, and the floatability of the platform 2 is locally increased at its stern 8.

As can be seen in FIGS. 1, 2 and 4, the platform 2 comprises, at its stern 8, a flotation beam 11 integral with the boxes 4 and extending transversely, connecting them. In addition to a function of coupling and bracing the boxes 4, and as rigidification of the platform 2, the beam 11 serves a floating function to permanently maintain the stern 8 at the level of the sea. In other words, as can be clearly seen in FIG. 4, the stern 8 follows the wave (represented by dotted lines in this figure).

In longitudinal cross-section (FIG. 4), the beam 11 can have any shape, but in order to optimize its floating function, it is preferable that it have a circular shape in longitudinal cross-section. Thus, in the illustrated example, the beam 11 is tubular, hollow, of circular cross-section. The vertical positioning of the beam 11 is adapted to the architecture of the platform 2, and in particular to the shape of the boxes 4; in the illustrated example, the beam 11 extends about halfway up the boxes 4.

The platform 2 further comprises at least one stabilizing aileron 12, which, at sea, is normally permanently immersed, said aileron 12 extending transversely beneath the lower edges 10 of the boxes 4, at the bow of the platform 2.

The bow aileron 12 extends over only one part of the length of the platform 2 (typically between ⅕ and 1/10 of said length).

The aileron 12 has a substantially flat upper face or surface 13, parallel to and facing lower longitudinal edges 10 of the boxes 4, and a lower face or surface 14 by which the platform 2 can be anchored to the sea floor by means of a catenary 15 integral with the platform 2. The anchoring of the catenary 15 to the aileron 12 allows the platform 2 to be automatically oriented to face the wave, the forces being applied in the axis thereof and ensuring a continuous tension of the catenary 15.

As can be seen in FIG. 1, the aileron 12 is U-shaped in transverse cross-section, and comprises two sides 16 that extend from the lower edges 10 of the boxes 4, in the vertical extension thereof, in such a way that the upper surface 13 extends at a distance from the lower edges 10 of the boxes 4 so that the aileron 12, situated beneath the boxes 4, is always immersed at a sufficient depth to be protected from the effects of the wave.

This results in the trim of the platform 2 being maintained stable thanks to the weight of the water column on top of the aileron 12, which acts as damper of the movements of the platform 2, particularly for rolling (or listing). The combined effects of the damping function of the aileron 12 and the anchoring of the platform 2 by the catenary 15 ensures that the bow 7 of the platform 2 is not sensitive to the wave action and maintains a substantially constant trim.

On the contrary, the stern 8 follows the wave as the result of the flotation of the stern ends of the boxes 4 combined with that of the beam 11. Thus, on the platform 2, the wave causes an oscillating movement of the stern 8, centered on an axis substantially along a median transverse line of the aileron 12.

The wave power generating machine 3 is mounted on the platform 2 at the bow 7 thereof, for example directly above the aileron 8. The machine 3 comprises, firstly, a gantry 17 mounted on the boxes 4, extending transversely between them, and which couples them at their upper edges 9.

Secondly, the wave power generating machine 3 comprises at least one movable float 18 mounted in the channel between the bow 7 and the stern 8 to enable the transformation of the wave energy into mechanical energy. According to a preferred embodiment illustrated in FIGS. 1, 2 and 4, the machine 3 comprises a transverse row of floats 18 disposed side by side in the channel 6.

In the illustrated example, there are four floats 18, i.e., one pair of side floats 18 adjacent to the boxes 4 on the sides of the channel 6, and one pair of central floats 18 mounted between the side floats 18 at the center of the channel 6. As a variant, the number of floats 18 could be greater.

Each float 18 is preferably contoured like a ship's hull, and for that purpose, has a front 19 oriented towards the bow 7 of the platform 2. As can be seen in FIG. 4, each float 18 extends beyond the aileron 12 towards the stern 8.

Each float 18 is mounted on a rigid jointed arm 20, mounted in rotation on a shaft 21 integral with the gantry 17. The shaft 21 is preferably common to all of the arms 20. Each arm extends towards the stern 8 from the shaft 21.

According to one embodiment, not shown, each float 18 can be articulated with respect to the arm 20. In this way, each float 18 pitches with the waves, independent of the angular position of its arm 20.

However, according to a preferred embodiment, the connection between the float 18 and its arm 20 is by recessed fitting. In other words, the arm 20 is rigidly integral with the float 18.

For purposes of rigidity, the junction between each float 18 and its arm 20 can even be supported by means of brackets 22. In said configuration, where the orientation of the float 18 with respect to the platform depends only on the angle of rotation of the arm 20, the energy production of the machine 3 is better because no loss due to friction is noted at the junction between the float 18 and its arm 20.

The gantry 17 is preferably dimensioned generously enough to form a machine room for accommodating and housing the other equipment of the power generator 1, particularly for converting the mechanical wave energy into hydraulic energy, then the hydraulic energy into electrical energy.

Thirdly, to that end, the machine 3 comprises, for each float 18, a converter 23 of mechanical energy into hydraulic energy. Said converter 23 comprises at least one hydraulic cylinder 24 having a cylinder 25 defining a chamber 26 filled with a hydraulic fluid and a piston 27 mounted slidably inside the chamber 26 and coupled to the arm 20.

More specifically, as illustrated in FIG. 3, the piston 27 is coupled to a wheel 28 integral with the rotation shaft 21 of the arm 20, so that the rotation of said wheel, caused by a rising or falling movement of the float 18 accompanying the wave, alternately acts upon the piston 27 to tension it (in the direction of the long straight arrow of FIG. 3) and to compress it by spring effect (in the direction of the short straight arrow of FIG. 3).

In order to limit the fatigue of the mechanical parts, the hydraulic cylinder 24 is preferably single-acting, being arranged so that the fluid is only compressed (and injected into an external fluid system connected to turbines that generate electricity, possibly stored in accumulators) when the piston 27 is tensioned.

In the illustrated example, each converter 23 comprises a pair of hydraulic cylinders 24 functioning in opposition (and both under tension), the pistons 27 of which are coupled to the wheel 28, so that each oscillation of the arm 20 alternately exerts a tension on each of the pistons 27, the wave energy being collected in this way both during the ascending and descending movements of the float 18, as well as during possible movements due to the horizontal thrust of the wave.

In order to prevent the tension forces exerted simultaneously on the pistons 27 of the set of floats 18 from resulting in an overall torque applied to the platform 2, tending to cause it to pivot around the shaft 21 of the arms 20, the wave energy converter machine 3 can be equipped with a force balancing system, for example in the form of a torque reversing mechanism interposed between the energy converter 23 and the arm 20.

The power generator 1 is preferably arranged so that the center of gravity of the floats 18 (which preferably extends directly above the anchoring point of the arm 20 on the float 18) is located at a distance from the beam 11 equal to about one-half of the average wavelength of waves in the maritime zone where the power generator 1 is installed. Thus, for example, for a wave having an average wavelength of 150 m, the distance from the beam 11 to the centers of gravity of the floats 18 should be about 75 m.

In this way, the boxes 18 and the beam 11 (which moves the stern 8) are moved in alternating movements in reverse direction, the amplitude of which corresponds to the vertical crest-to-trough distance of the wave. It can be seen in FIG. 4 that when the beam 11 is in the trough of a wave, the floats 18 are on the crest of the following wave. Conversely, when the beam 11 is on the crest of a wave, the floats are in the trough thereof. This opposition of phase allows the angular amplitude of the rotational movement of the arm 20 to be maximized with respect to the platform 2.

Various design artifices make it possible to optimize the operation of the power generator 1.

In particular, as illustrated in FIG. 5, the lower edge 10 of each box 4 can be V-shaped, so as to improve the penetration of the box 4 in the water and minimize the bending forces induced by the wave thereupon.

Similarly, each float 18 has a hull 29 that, in transverse cross-section (FIG. 6) is more V-shaped than flat, so as to improve the penetration of the float 18 in the water.

Moreover, each float 18 can be equipped with a hydrodynamic appendage 30 to increase the amplitude of displacement of the float 18 and the value of the drive torque exerted by the arm 20 on its shaft 21 of rotation.

According to one embodiment illustrated in FIG. 7, the hydrodynamic appendage 30 is in the form of a trough attached beneath the hull 29 of the float 18, either directly (as in the illustrated example), or by means of a strut (not shown). As can also be seen in FIG. 7, the width of the trough 30 is greater than the length of the float 18, its side edges being spaced away from the side walls of the float 18. The result is the following configuration:
on the one hand, a local restriction of the cross-section of passage of the wave at the floats 18, which raises the water level and thus increases the amplitude of the wave (and therefore the movement of the floats)
and on the other hand, an increase, at the front 19 of the apparent front surface (and thus the coefficient of drag) of the floats 18, which increases the frontal pressure exerted by the water, and therefore the drive torque exerted by each float 18 on the shaft 21 of rotation of its arm 20.

In this way, each float 18 makes it possible to collect the sum of the flotation forces due to the wave, and of the forces resulting from the frontal thrust of the waves.

There are several advantages of the architecture of the power generator 1 that has just been described.

First, as we have seen, the presence of the flotation beam 11 at the stern 8 of the platform 2, at a distance from the floats 18 equal to about one-half of the average wavelength of the swell, makes it possible to maximize the angular amplitude of the oscillation movement of the arms. The result is an amplification of the collection of energy from the wave, and consequently increased energy output.

Secondly, the boxes 4 together form an effective barrier against the listing of the platform 2 (and therefore of the power generator 1), which allows the wave to be effectively channeled into the channel 6, thus optimizing the operation of the floats 18. Moreover, the floats 18 are thus protected from the transverse forces that are likely to hinder their proper rotation around their shaft 21. The result is increased transverse stability of the power generator 1, and better reliability thereof.

Thirdly, mounting the boxes between the bow 7 and the stern 8 of the platform 2 offers good compactness (and thus better rigidity) to the power generator 1, which in particular minimizes manufacturing costs.

It should be noted that it is possible to couple a plurality of power generators 1, either by aligning them along the same line of waves, or by longitudinally offsetting them (i.e., in the direction of the swell).

A number of variants can be considered without going beyond the scope of the present invention.

Thus, represented in FIG. 8 is a variant of the power generator 1, in which the stabilizing aileron 12 is mounted articulated with respect to the boxes 4, and more specifically with respect to the sides 16, around a central shaft 31.

Said articulation allows the aileron 12 to remain substantially horizontal while the platform 2 pivots with the swell, moved by the flotation beam 11.

The result is better facility of pivoting of the platform 2, since the aileron 12 no longer offers resistance to its own tilting.

Moreover, as can also be seen in FIG. 8, the aileron 12 can be provided with a counterweight 32 that projects below the lower face 14 and serves as a keel, maintaining the trim of the aileron 12.

According to another variant of embodiment, which can be combined with the preceding one, each float 18, instead of being shaped like a boat hull, has a cylindrical shape that limits its axial extension (i.e., parallel to the long axis of the platform 2) and thus makes it less sensitive (even insensitive) to the bending forces that a float having the shape of a boat hull undergoes due to the passage of the swell.

According to yet another variant of embodiment, illustrated in FIG. 10, the platform 2 comprises a single floating box 4 arranged centrally, on either side of which are distributed the floats 18, the gantry 17, the stabilizing aileron 12 and the flotation beam 11, which remains integral with the box 4 at the stern 8. The shape of the box 4 remains unchanged overall, although preferably, it has a greater thickness (measured transversely) for purposes of mechanical strength and rigidity.

The number of floats 18 illustrated (eight in this instance) corresponds to one embodiment, but there could be fewer (reduced to two distributed on either side of the central box 4), or more.

1. A wave power generator (1), which comprises:
a semi-submersible platform (2) having at least one longitudinal box (4) that extends from a bow (7) to a stern (8) of the platform (2), said platform (2) having at the stern (8) a transverse floatation beam (11) integral with the box (4);
a wave energy converter machine (3) mounted on the platform (2), said machine (3) comprising:
a gantry (17) mounted transversely on the box (4) at the bow of the platform (2),
at least one float (18) arranged to allow the transformation of the wave energy into mechanical energy, the float (18) being mounted on an arm (20) mounted in rotation on a shaft (21) integral with the gantry (17),
a converter (23) of mechanical energy from the float (18) into hydraulic energy, and
a stabilizing aileron (12) that extends transversely below a lower edge (9) of the box (4).

2. The wave power generator (1) according to claim 1, wherein the beam (11) has a circular contour in longitudinal cross-section.

3. The wave power generator (1) according to claim 1, wherein the beam (11) extends to about halfway up the box (4).

4. The wave power generator (1) according to claim 1, wherein each box (4) has, at the stern (8), a widened and/or raised end.

5. The wave power generator (1) according to claim 1, wherein the gantry (17) extends directly above the aileron (12).

6. The wave power generator (1) according to claim 1, wherein each converter (23) comprises a pair of hydraulic cylinders (24) functioning in opposition, the pistons (27) of which are coupled to the arm (20).

7. The wave power generator (1) according to claim 1, wherein each arm (20) is rigid.

8. The wave power generator (1) according to claim 1, wherein each arm is rigidly integral with the float (18).

9. The wave power generator (1) according to claim 1, wherein each float (18) comprises a hydrodynamic appendage (30) in the form of a trough attached beneath a hull (29) of the float (18)

10. The wave power generator (1) according to claim 1, which comprises at least two longitudinal boxes (4) defining a central channel (6) in which the float (18) is disposed, wherein the gantry (17) is mounted transversely between the boxes (4), and wherein the flotation beam (11) transversely connects the boxes (4).
